(19) United States
(12) Patent Application Publication
(10) Pub. No.: US 2008/0127444 A1
(43) Pub. Date: Jun. 5, 2008

(54) Cleaning device for removing foreign matter deposited on work

(75) Inventor: Kaoru Ichihashi, Higashiomi-Shi (JP)

Correspondence Address: VENABLE LLP, P.O. BOX 34385, WASHINGTON, DC, 20043-9998, US

(73) Assignee: Shigayamashita Co., Ltd., Higashiomi-Shi (JP)

(21) Appl. No.: 11/976,195

(22) Filed: Oct. 22, 2007

(30) Foreign Application Priority Data
Oct. 23, 2006 (JP) 2006-287699

(51) Int. Cl. B08B 3/02

(52) U.S. Cl. 15/306.1; 15/322

(57) ABSTRACT

[Problem] Provision of a cleaning device for removing foreign matter such as machining dust, or cutting oil (machining oil) which remains on a surface, an inside surface of a casting core-derived hollow, an inside surface of a threaded hole or the like of a work such as an auto part, which device has a reduced size and exhibits particularly high cleaning efficiency

[Means to Solve the Problem] The cleaning device comprises: a cleaning chamber 3 provided with an opening 2; a work holding jig 4 disposed in the cleaning chamber 3; a driving unit 5 for rotationally driving the jig 4 by means of a servo motor, the driving unit being disposed outside the cleaning chamber 3; cleaning nozzles 6 mounted on the jig 4 and a liquid discharge port 7 for discharging a cleaning liquid from the cleaning chamber 3.

### TECHNICAL FIELD

The present invention relates to a cleaning device for removing foreign matter such as machining dust, i.e., dust resulting from machining, or cutting oil (machining oil) which remains on a surface, an inside surface of a casting core-derived hollow, an inside surface of a threaded hole or the like of a work such as an auto part. In particular, it relates to a cleaning device which is so constructed as to have neither a large size nor a complicated structure.

### BACKGROUND ART

A cylinder cover or a cylinder block which is an engine part of an automobile has a lot of threaded holes or water jacket holes. After subjected to machining, these auto part works are assembled. In this connection, after the machining, foreign matter such as machining dust, cutting oil (machining oil) or the like remains on surfaces, inside surfaces of casting core-derived hollows or inside surfaces of threaded holes of the works. Accordingly, it is necessary to remove the foreign matter prior to the assembly.

As a technique for removing such foreign matter, a device has heretofore been employed which directly applies a jet of pressurized cleaning liquid to foreign matter in a hole or the like to remove the foreign matter. For example, since a cylinder cover or a cylinder block which is an engine part of an automobile has a lot of threaded holes or water jacket holes, the work is positioned in a posture which facilitates removal of foreign matter in the holes, and a cleaning nozzles fit for the condition are provided.

In this technique, however, the cleaning device inevitably has a large size and a complicated structure. Further, the jig which positions the work and the cleaning nozzles are exclusive to one form of the work.

Accordingly, when a work having another form is cleaned, it is necessary to use different jig and cleaning nozzles even if these forms are similar to each other. This requires very marked alteration of the device.

Patent Document 1: Japanese Unexamined Patent Publication No. 2000-91903.

### DISCLOSURE OF INVENTION

### Problem to be Solved by the Invention

The problem to be solved by the present invention is to provide a cleaning device which is capable of rapidly removing, with a simple structure in a short time, foreign matter such as machining dust, cutting oil (machining oil) or the like remaining on a surface, an inside surface of a casting core-derived hollow, an inside surface of a threaded hole or the like of a work such as an auto part, and which is thereby capable of overcoming the drawbacks inherent in the above-described known technique.

### Means to Solve the Problem

To solve the above-described problem, the cleaning device for removing foreign matter deposited on a work according to the present invention characteristically comprises:

a cleaning chamber provided with an opening for introducing a work;

a work holding jig disposed in the cleaning chamber;

a driving unit for rotationally driving the jig by means of a servo motor, the driving unit being disposed outside the cleaning chamber;

cleaning nozzles provided in the cleaning chamber; and

a liquid discharge port for discharging a cleaning liquid accumulated in the cleaning chamber from the cleaning chamber.

### EFFECT OF THE INVENTION

According to the present invention, a work is driven by the servo motor disposed outside the cleaning chamber, and a transfer system and the cleaning system are separated, and further, cleaning and liquid discharge are carried out with the work in the optimum postures because of the driving by the servo motor. By virtue thereof, size reduction and simplification of the device are realized, and cleaning efficiency is enhanced. With the conventional technique, since a work is not driven by a servo motor, it is difficult to realize such optimization.

### BEST MODE FOR CARRYING OUT THE INVENTION

In the following, the present invention will be described in detail with reference to the accompanying drawing.

FIG. 1 is a sectional view of an embodiment of the cleaning device according to the present invention.

As shown in FIG. 1, a cleaning device A of the present invention mainly comprises a cleaning chamber 3 provided with an opening 2 for introducing a work 1, a jig 4 for holding the work 1, a driving unit 5, cleaning nozzles 6, and a liquid discharge port 7.

The cleaning chamber 3 is provided with a shutter 8 for the opening, i.e., an opening shutter 8. When the work 1 is introduced into the chamber 3, the opening shutter 8 is opened to introduce the work. When the work 1 is taken out of the chamber 3, the opening shutter 8 is opened to remove the work. During cleaning operation, the opening shutter 8 is closed.

The holding jig 4 is a jig for holding the work 1 introduced from the opening 2 into the cleaning chamber 3. The holding jig 4 clamps the work 1 with a clamp 9, and a cleaning liquid in a container disposed outside the cleaning chamber 3 is sent to the cleaning nozzles 6 through a piping 10 to apply a jet of the cleaning liquid to the work 1. During the jet application, the work 1 is rotated about a rotating center shaft 11.

In other words, the cleaning is carried out while rotating the jig 4 and the work 1. To optimize postures of the work in the cleaning, cleaning time, speed of rotation, and postures of the work in discharging of the cleaning liquid, a servo motor incorporated in the driving unit is used in the driving unit 5 for numerical control (NC-control). Reference number 12 represents radius of the rotation of the work 1 and the jig 4.

A level of the liquid surface 13 of the cleaning liquid which has been collecting in the cleaning chamber 3 rises upward in the direction shown by the arrow, and the cleaning is continued even when the work 1 is immersed in the liquid. Accordingly, the liquid present around the jet of the liquid from the nozzle is involved, and the liquid runs against the work 1 in a broader area to enable cleaning of other area than that directly exposed to the jet of the liquid from the nozzles, as well. During the time when the work is immersed in the liquid, a portion of the work which has narrow ports and thus which is generally difficult-to-wash (difficult-to-clean), such as a water jacket or the like is also washed. When the work is in such a posture that the liquid in the interior is drained most easily, a dumper 14 of the discharge port 7 is opened to cause the cleaning liquid to swiftly drain in the direction shown by the arrows. This enables the hollow having a deep interior to be surely cleaned.

### INDUSTRIAL APPLICABILITY

The cleaning device A of the present invention is a compact cleaning device by virtue of the facts that it is driven by the servo motor disposed outside the cleaning chamber and that the transfer system and the cleaning system are separated from each other. Further, since the cleaning device is driven by the servo motor, the cleaning and the discharge of the cleaning liquid can be carried out with the work in the optimum postures. Accordingly, enhanced cleaning efficiency is realized. In the conventional technique, since the device is not driven by a servo motor, such optimization is difficult. As described above, the cleaning device A of the present invention has high industrial applicability.

### BRIEF DESCRIPTION OF DRAWING

FIG. 1 is a sectional view showing an embodiment of the cleaning device of the present invention.

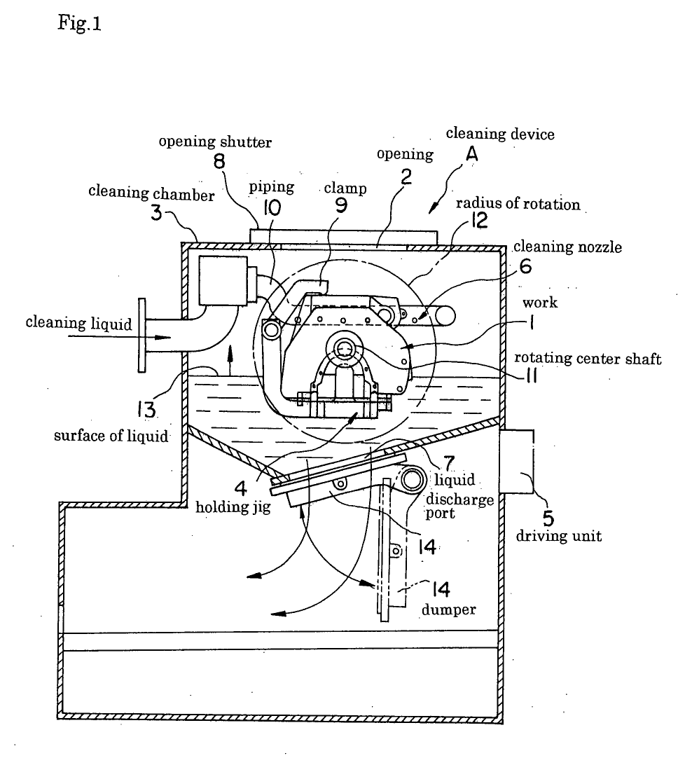

### NOTE ON (REFERENCE) DESIGNATORS

A: cleaning device

1: work

2: opening

3: cleaning chamber

4. holding jig

5: driving unit

6. cleaning nozzle

7. liquid discharge port

8. opening shutter

9: clamp

10: piping

11: rotating center shaft

12: radius of rotation

13: surface of liquid

14: dumper

1. A cleaning device for removing foreign matter deposited on a work, said cleaning device comprising:
a cleaning chamber provided with an opening for introducing a work;
a work holding jig disposed in the cleaning chamber;
a driving unit for rotationally driving the jig by means of a servo motor, said driving unit being disposed outside the cleaning chamber;
cleaning nozzles provided in the cleaning chamber; and
a liquid discharge port for discharging a cleaning liquid accumulated in the cleaning chamber from the cleaning chamber.

2. The cleaning device according to claim 1, wherein the servo motor is numerically controlled.
